(19) United States
(12) Patent Application Publication
(10) Pub. No.: US 2022/0063964 A1
(43) Pub. Date: Mar. 3, 2022

(54) PRECISION MOVEMENT DIRECTIONAL ACTUATOR SYSTEM

(71) Applicant: Brian Conville, San Jose, CA (US)

(72) Inventor: Brian Conville, San Jose, CA (US)

(21) Appl. No.: 17/459,737

(22) Filed: Aug. 27, 2021

Related U.S. Application Data
(60) Provisional application No. 63/071,917, filed on Aug. 28, 2020.

(51) Int. Cl. B66C 13/08; B66C 1/12

(52) U.S. Cl. CPC B66C 13/08; B66C 23/485; B66C 1/12

(57) ABSTRACT

An apparatus according to one embodiment includes an actuator mechanism having a first crossbar oriented along an x-axis, a second crossbar oriented along a y-axis that is perpendicular to the x-axis, and at least one actuator coupled to each of the crossbars. The actuator mechanism is configured to provide controlled movement and setting of x-axis and y-axis angles of the crossbars in vertical planes extending along the respective axis. An apparatus according to another embodiment includes an actuator mechanism for controlling orientation of an item suspended from the actuator mechanism. The actuator mechanism has at least one load leveler for providing controlled movement of the item in an x-axis angle and/or a y-axis angle.

### RELATED APPLICATION

This application claims priority to U.S. Provisional Appl. No. 63/071,917 filed Aug. 28, 2020, which is herein incorporated by reference.

### FIELD OF THE INVENTION

The present invention relates to precision hoist movement, and more particularly, this invention relates to a precisely movable actuator mechanism usable for such things as hoisting an engine in and out of a motorized vehicle.

### BACKGROUND

Typical engine hoists that have been used in automotive car repair and motorized vehicle engine replacement have been manual in nature and are of three common types. 1) A fixed chain and pulley system suspended from a building structure and mounted on a rail. 2) Hydraulic forklifts have also been used. 3) The most commonly used are hydraulic fluid-based cylinder lifts on cart stands. Control, of this third and most common type during lift, has been when a screw valve is closed and pressure is built up with a manual pump lever. Lowering is initiated by slight opening of the screw valve, thereby releasing the built-up pressure. Various permutations of these three systems have included some attachments that enable change of angle and/or pitch that can be manually adjusted during lift and lowering. The attachments are simple screw rotary load levelers that work on one axis and change the center point for weight distribution.

Existing engine hoists, as described above, suffer from a common limitation of lacking smooth and precise movement. In addition, they are limited in their ability to combine a change of angle during the lifting and lowering without stopping to make the angle adjustment. For example, in the third and most common type (hydraulic fluid-based cylinder lifts on cart stands) when the screw valve is opened slightly for lowering, the engine will often fall several inches more than desired in a quick jerking fashion. This can cause risk of damage to the other components near the engine, e.g., freshly painted car panels or chromed components in the engine bay, wiring, harnesses, the engine itself, etc. This can cause costly rework. Additionally, the need to adjust the angle to maneuver the engine into the car chassis structure requires a long and arduous process of lowering, stopping, change of angle, lowering a bit more, stopping, change of angle, repeatedly until complete. A similar process is performed in reverse when removing an engine. This is time consuming, dangerous, and inefficient.

Prior engine hoists also suffer from a lack of bi-directional movement. As mentioned above, to change the angle of the engine, it must be adjusted separately from the height. Additionally, most common hoists can only be changed in one direction or axis for angle. This limits maneuverability around obstacles in the engine bay while lifting and/or lowering.

### SUMMARY

An apparatus according to one embodiment includes an actuator mechanism having a first crossbar oriented along an x-axis, a second crossbar oriented along a y-axis that is perpendicular to the x-axis, and at least one actuator coupled to each of the crossbars. The actuator mechanism is configured to provide controlled movement and setting of x-axis and y-axis angles of the crossbars in vertical planes extending along the respective axis.

An apparatus according to another embodiment includes an actuator mechanism for controlling orientation of an item suspended from the actuator mechanism. The actuator mechanism has at least one actuator coupled to a crossbar for providing controlled movement of the crossbar in an x-axis angle thereby controlling an x-axis angle of the item, and a load leveler for providing controlled movement of the item in a y-axis angle.

An apparatus according to yet another embodiment includes an actuator mechanism for controlling orientation of an item suspended from the actuator mechanism. The actuator mechanism has a first load leveler for providing controlled movement of the item in an x-axis angle, and a second load leveler for providing controlled movement of the item in a y-axis angle.

### BRIEF DESCRIPTION OF THE DRAWINGS

FIG. 1 is a front view of an actuator mechanism according to one embodiment.

FIG. 2 is a side view of the actuator mechanism shown in FIG. 1.

FIG. 3 depicts left leaning angle adjustment of the actuator mechanism shown in FIG. 1.

FIG. 4 depicts right leaning angle adjustment of the actuator mechanism shown in FIG. 1.

FIG. 5 depicts downward leaning angle adjustment of the actuator mechanism shown in FIG. 1.

FIG. 6 depicts upward leaning angle adjustment of the actuator mechanism shown in FIG. 1.

FIG. 7 depicts left and downward compound angle adjustment representing one of many achievable compound angle positions of the actuator mechanism shown in FIG. 1.

FIG. 8 is a representational view of the actuator mechanism in use as part of an engine hoist according to one embodiment.

FIG. 9 is a representational view of the actuator mechanism as an accessory to a common forklift according to one embodiment.

FIG. 10 is a representational view of the actuator mechanism as an accessory to a common “Cherry-Picker” hydraulic cylinder stand engine hoist according to one embodiment.

FIG. 11 includes side and top representational views of an exemplary input control joystick according to one embodiment.

FIG. 12 is a representational view of an exemplary linear actuator controller sending unit and illustrative circuit diagram according to one embodiment.

FIG. 13 is a front view of an actuator mechanism utilizing one or more load levelers, according to another embodiment.

FIG. 14 depicts left leaning angle adjustment of the actuator mechanism shown in FIG. 13.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments of an apparatus comprising an actuator mechanism that can be used by itself and/or with additional components for hoisting an item of any type in and/or out of a confined space. Various embodiments are particularly suited to hoisting an engine in and out of a vehicle. For example, various embodiments described herein deal with the precise movement control of a hoist mechanism for hoisting an engine in and out of a motorized vehicle. To place the various embodiments in a context, much of the description herein refers to hoisting an engine into and out of a vehicle. This is done by way of example, and it should be understood that the embodiments may be used with objects of any type and thus no embodiment should be limited specifically to use solely with an engine.

As previously mentioned, existing engine hoists as described above suffer from a common limitation of lacking smooth and precise movement. In addition, they are limited in their ability to combine a change of angle during the lifting and lowering without stopping to make the angle adjustment. For example, in the most common type (hydraulic fluid-based cylinder lifts on cart stands), when the screw valve is opened slightly for lowering, the engine will often fall several inches more than desired in a quick jerking fashion. This can cause risk of damage to the other components near the engine, as mentioned above. This can cause costly rework. Additionally, the need to adjust the angle to maneuver the engine into the car chassis structure requires a long and arduous process of lowering, stopping, change of angle, lowering a bit more, stopping, change of angle, repeatedly until complete. A similar process is performed in reverse when removing an engine. This is time consuming, dangerous, and inefficient.

In sharp contrast, various embodiments described herein enable smooth, controlled movement and angle adjustment.

Use of this actuator mechanism in the various embodiments described herein improves user safety by allowing a person to avoid putting his or her hands in precarious positions when trying to angle the object, e.g., engine, being lifted. The user is able to adjust angles remotely, e.g., via a joystick, mobile and/or computer application interface, etc. without direct manual intervention of the mechanisms of the hoist itself.

Use of this device in the various embodiments described herein helps avoid damage to the object/components/engine being lifted or lowered. It will also help avoid damaging the vehicle/components/paint that the object/engine is installed in or removed from.

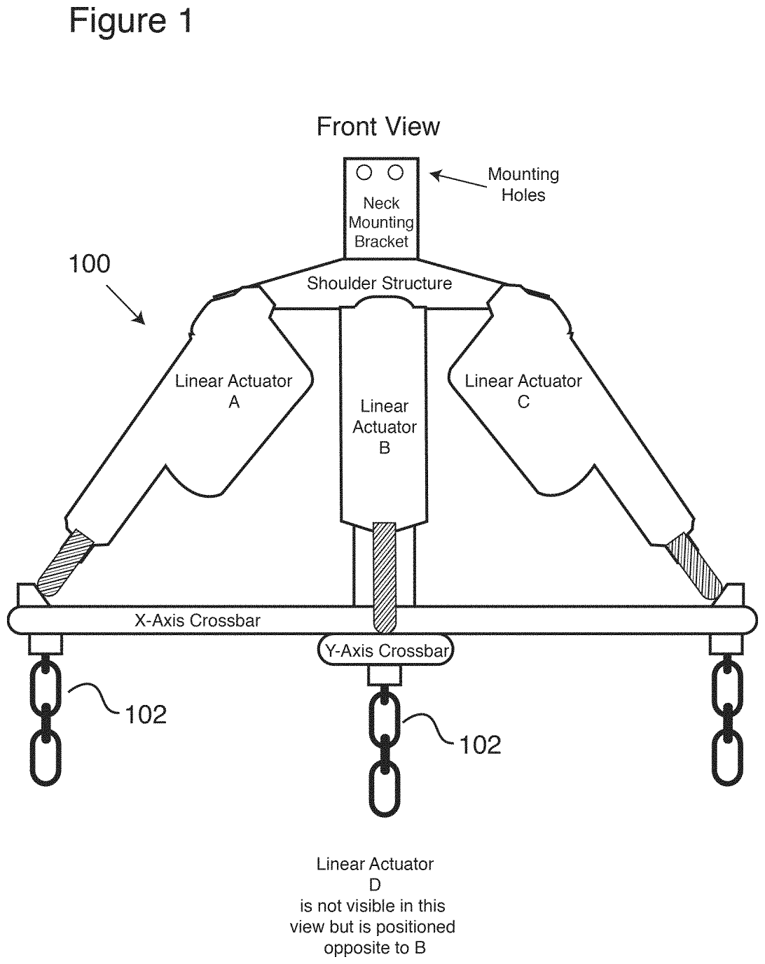

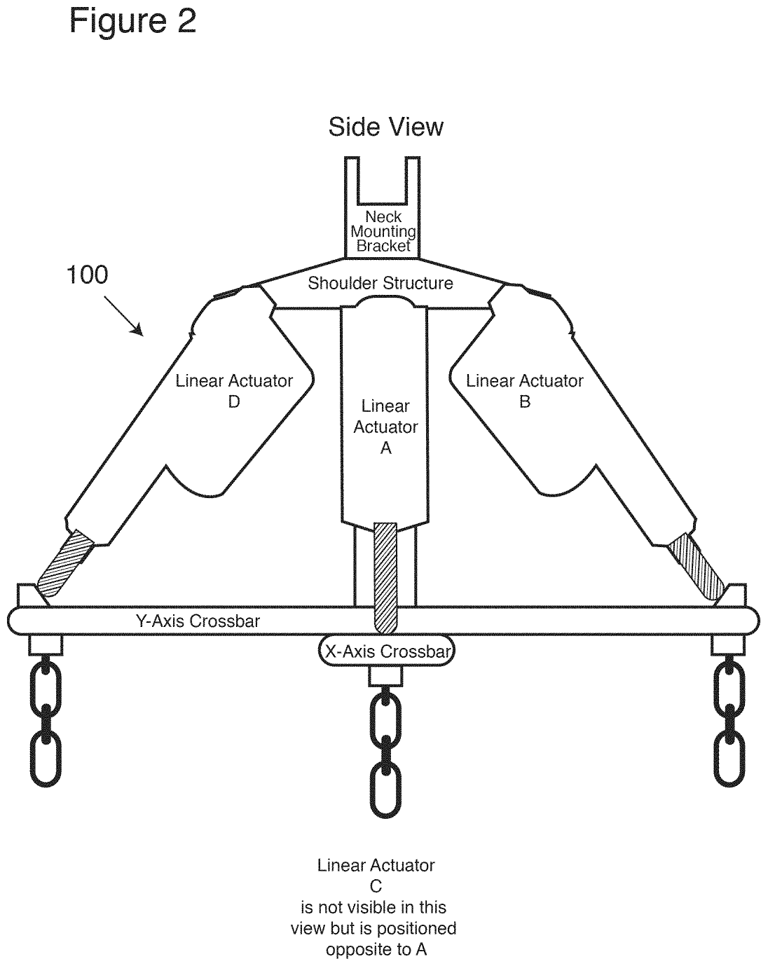

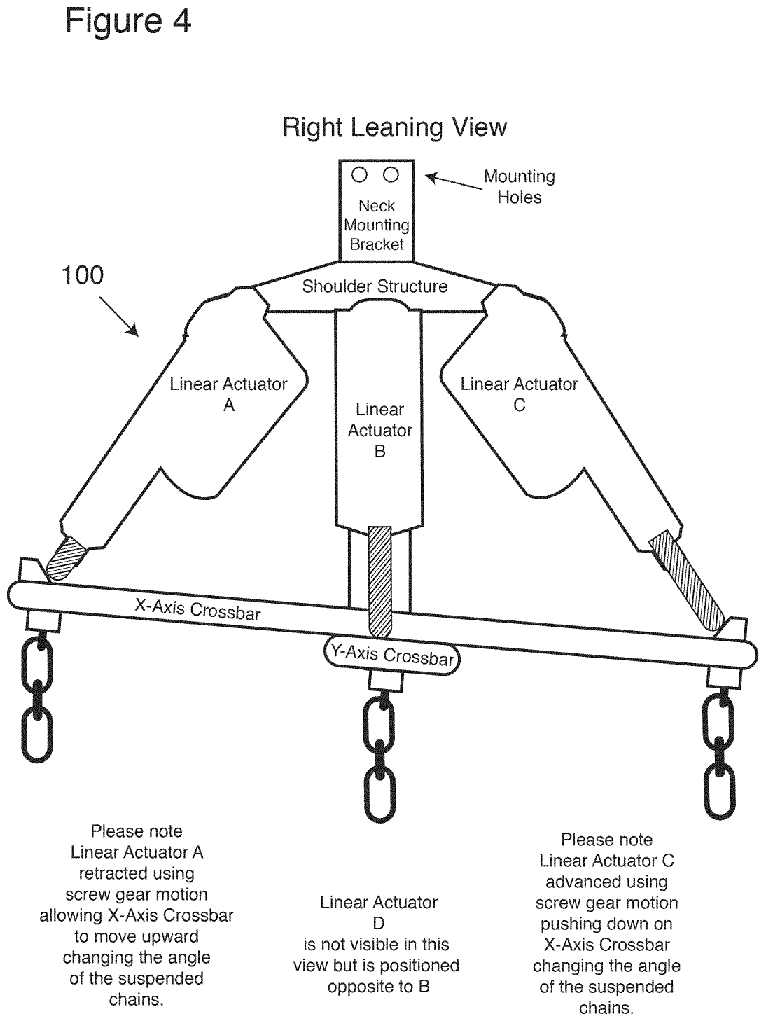

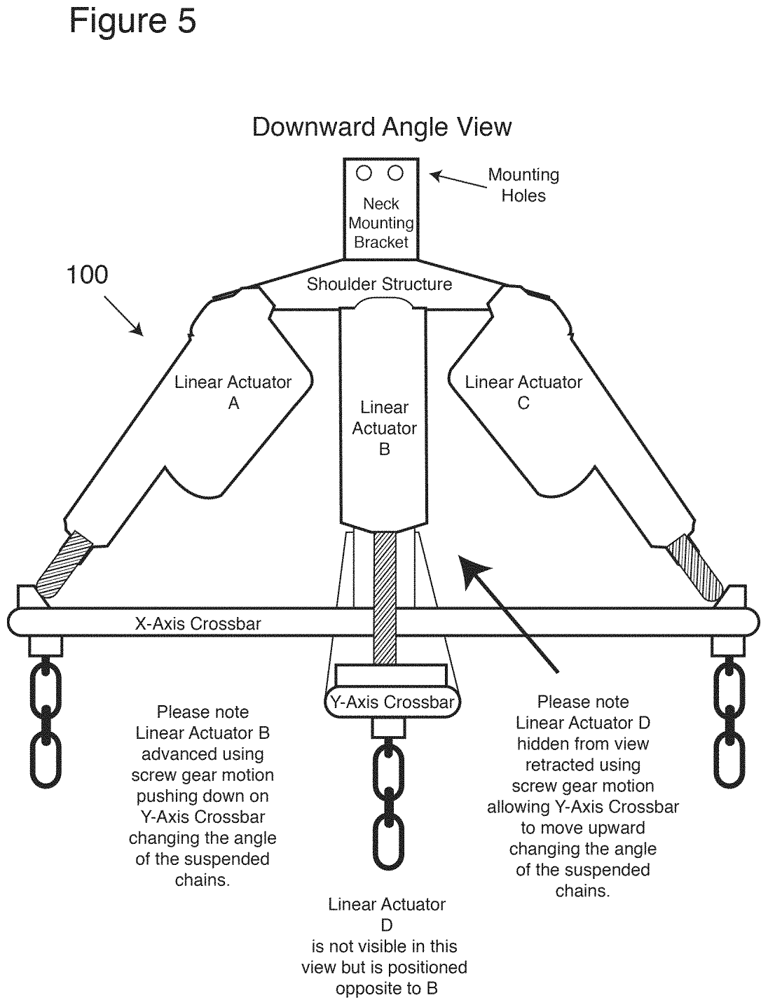

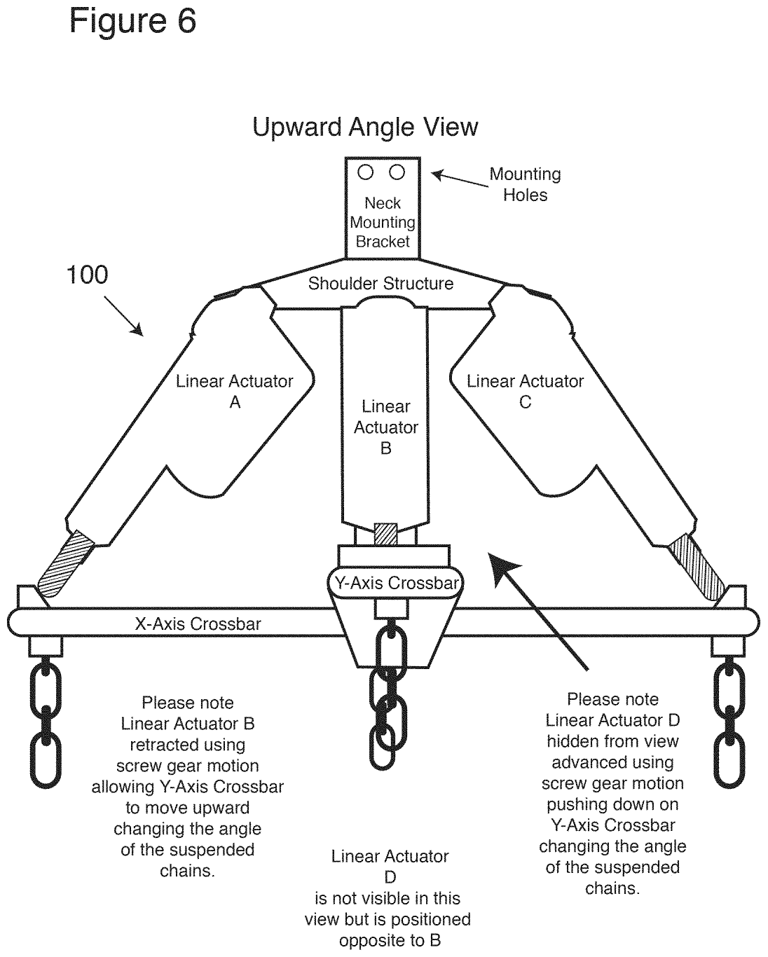

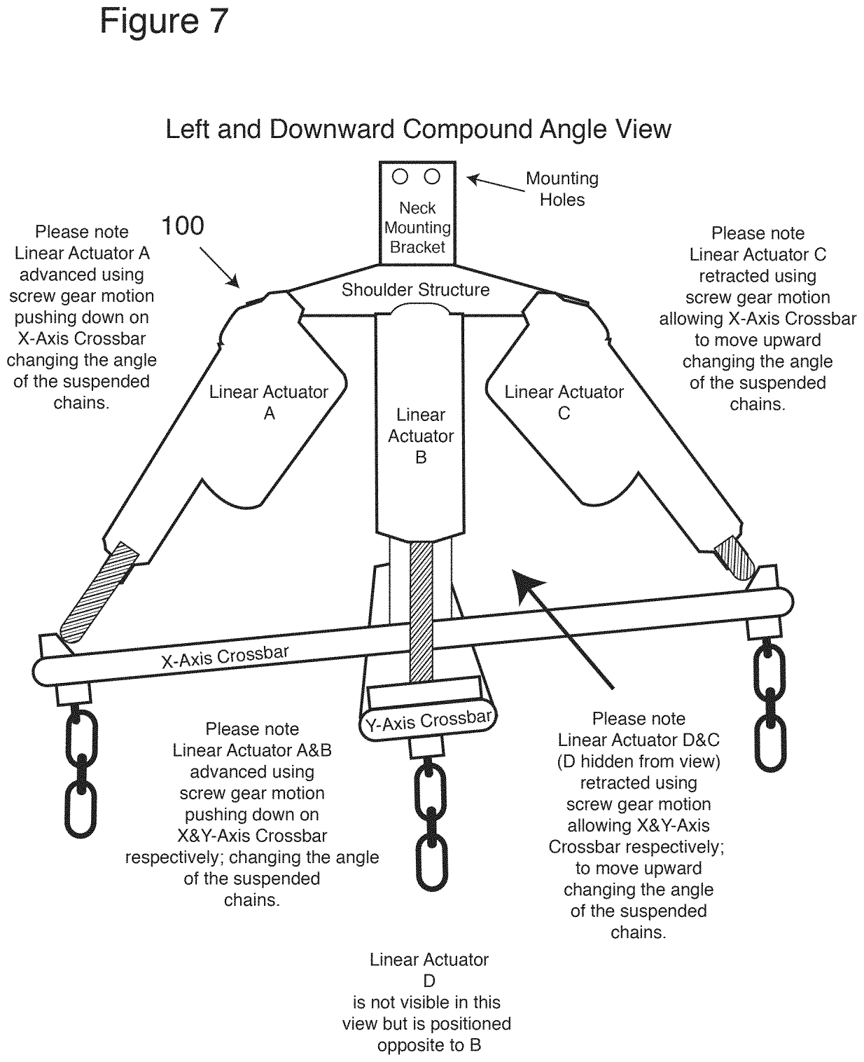

The actuator mechanism 100 shown in FIGS. 1-7 includes a plurality of actuators (Linear Actuator A, Linear Actuator B, Linear Actuator C, Linear Actuator D) coupled to a common shoulder structure (Shoulder Structure). Preferably, the actuators are pivotally coupled to the shoulder structure.

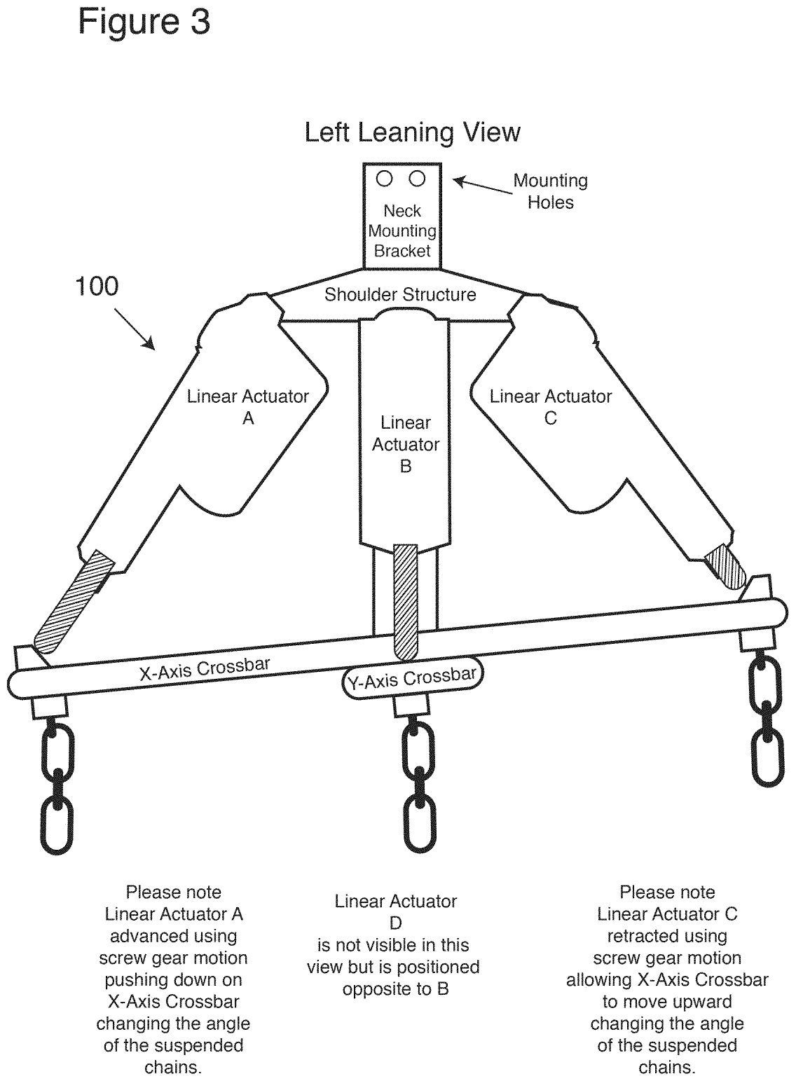

Three or more actuators may be used, thereby providing control of both vertical lift, and control of the angle of the suspended object relative to a horizontal plane. Preferred embodiments have four actuators, thereby providing precise control, as shown in FIGS. 3-7. Simpler embodiments may have two actuators, one for control of vertical lift, and one for control of the angle of the suspended object in one vertical plane. Yet another embodiment has two actuators, one for control of the angle of the suspended object in one vertical plane, and one for control of the angle of the suspended object in a perpendicular vertical plane.

The actuators may be any type of actuators. Preferably, the actuators are linear actuators. Illustrative types of actuators include electric screw gear linear actuators, hydraulic piston linear actuators, pneumatic piston linear actuators, and combinations thereof.

Crossbars (X-Axis Crossbar, Y-Axis Crossbar) extend between opposing actuators to minimize swing and sway of the object being positioned by the actuator mechanism. Preferably, the crossbars are constructed at least in part of metal.

The actuators may be bolted, welded, etc. to a shoulder structure that is rigid, thereby providing a solid structure that enables driving the actuators in the appropriate direction for generating the pushing and/or pulling force necessary to change the position of the respective crossbars.

Preferably, during the angle and tilt adjustment, e.g., either during lift or when paused, the actuator mechanism drives the corresponding crossbar and chain (in or out) or (up or down) creating the angle or tilt desired, ideally while maintaining even tension for all chains. This will cause the object to maintain the desired angle tilt positioning.

The crossbars are secured in the center, e.g., by a bolt, to center shaft of the shoulder structure. The center shaft of the shoulder structure has a pivotal coupling, such as a circular ball end acting like a bearing knuckle or other known type, that allows the crossbars to rotate and allows the articulation of each crossbar on the given x&y axis.

Suspension members 102 such as chains, cables or other types of straps are attached and suspended from the crossbars. The suspension members may each have or be used with a clasp, hook, etc. that may connect through an anchor plate that can be attached to the engine, motor or other object being lifted and/or manipulated.

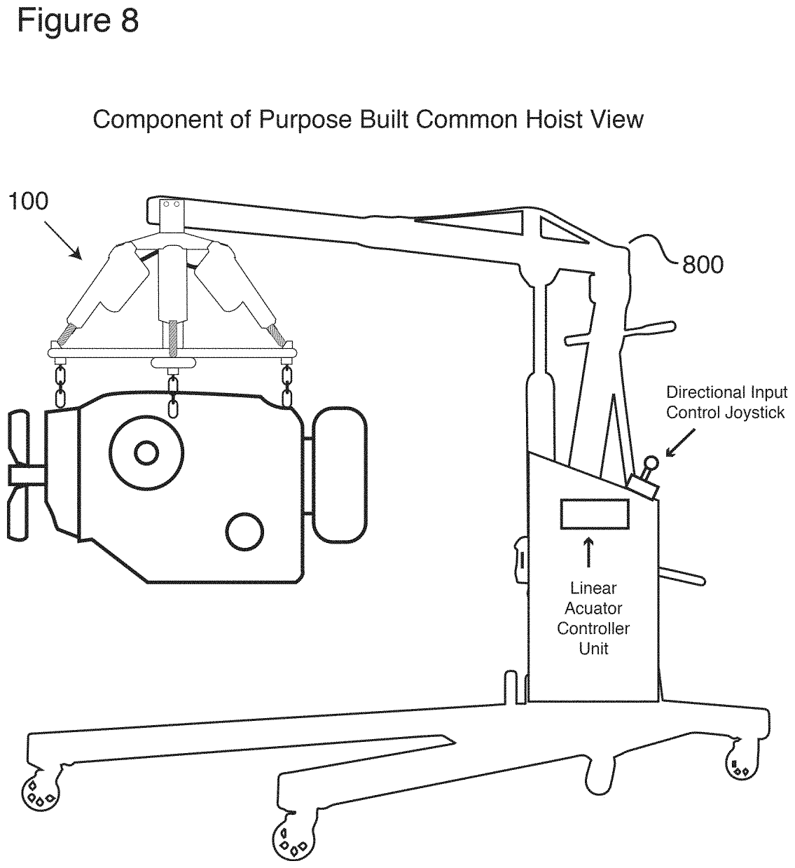

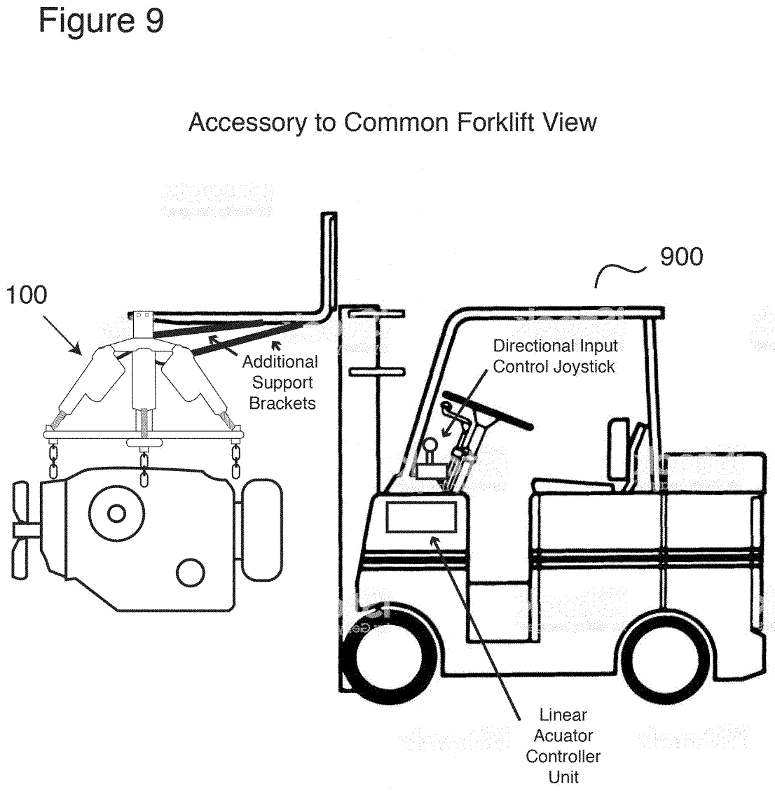

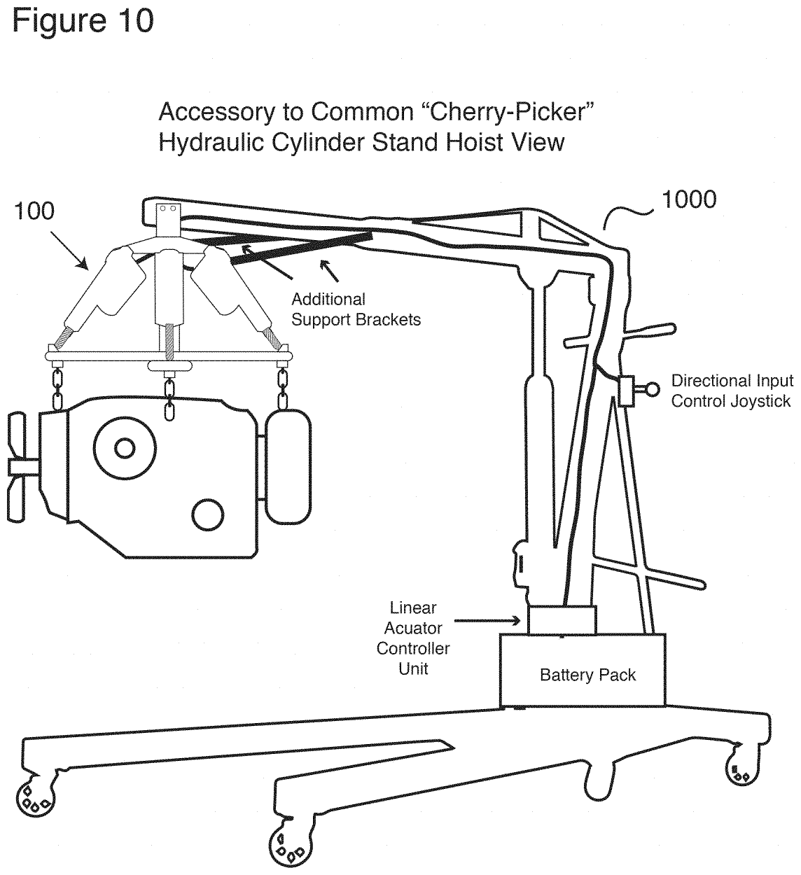

The shoulder structure may include or be coupled to an optional neck mounting bracket (Neck Mounting Bracket) with mounting holes (Mounting Holes) or other type of coupling mechanism that enables mounting of the actuator mechanism to another device. See, e.g., FIGS. 8-10, depicting an actuator mechanism mounted to a hoist 800, a forklift 900, and a cherry-picker type stand hoist 1000, respectively.

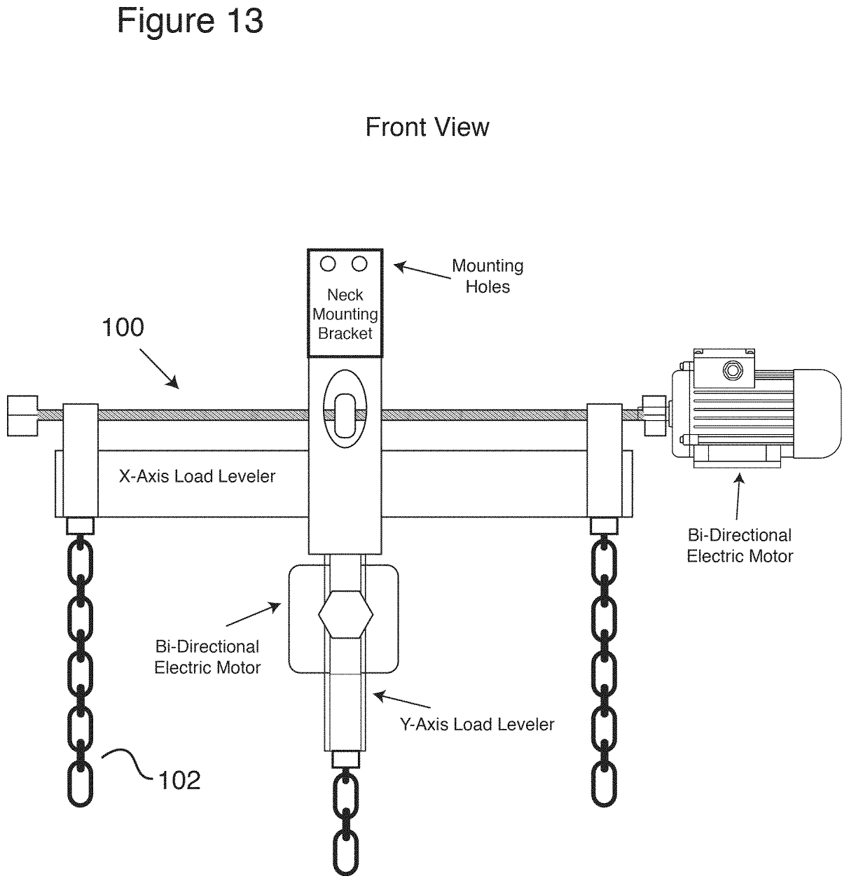

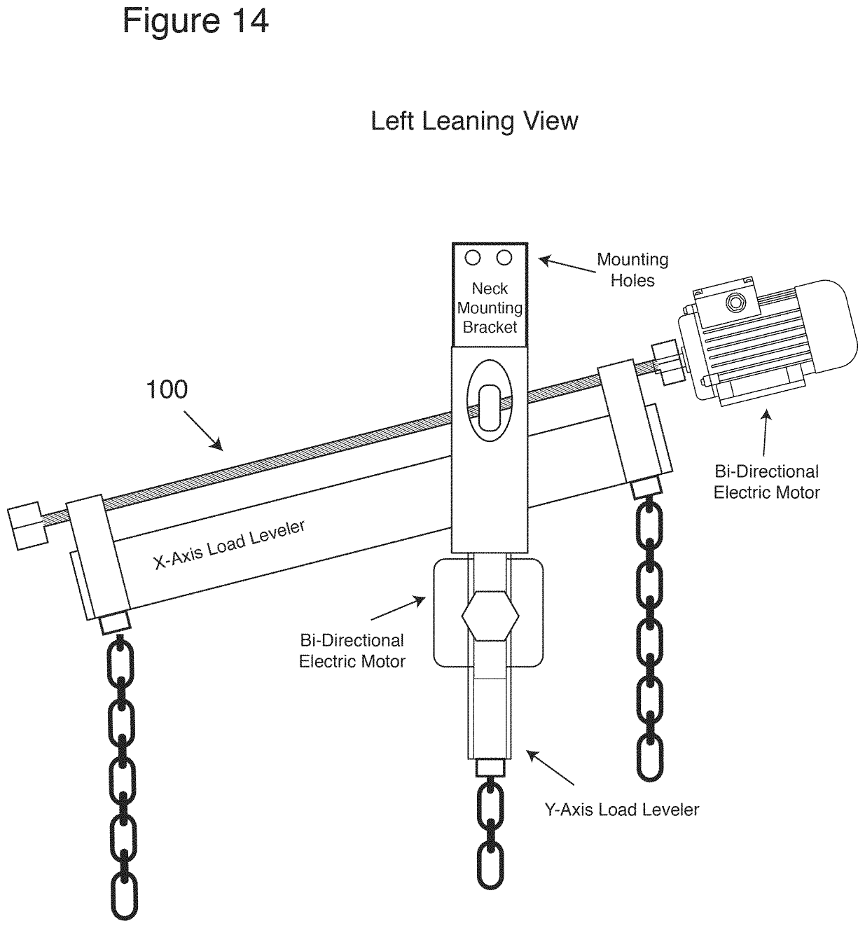

An actuator mechanism according to another embodiment includes one or more mechanical load levelers driven by an associated bi-directional driver, e.g., electric motor with worm gear, electric motor with chain drive, a linear actuator, etc. to precisely adjust the x and/or y axis of angle for the purpose of hoisting any type of object, such as an engine from a vehicle such as an automotive vehicle. In one approach, a single load leveler may be used in place of one of the crossbars/actuator systems of the actuator mechanisms described above, e.g., with reference to FIG. 1. In another approach, e.g., as shown in FIGS. 13-14, two orthogonally-oriented load levelers (X-Axis Load Leveler, Y-Axis Load Leveler) may be present in an actuator mechanism 100 to enable independent adjustment of the x and y axes. Each bi-directional driver (Bi-Directional Electric Motor) drives one of the load levelers.

In operation, the bi-directional driver(s) are instructed to adjust the center point of the load leveler, which results in repositioning of the item suspended therefrom along the corresponding axis, and also creating the angle or tilt desired. This will cause the object to maintain the desired angle tilt positioning.

The neck mounting bracket (Neck Mounting Bracket) enables mounting of the actuator mechanism to another device to create a larger apparatus. See, e.g., FIGS. 8-10.

The actuator mechanism according to any embodiment described herein may be part of, and/or coupled to, a device that includes additional components. See, e.g., FIGS. 8-12. Such device may be of known type.

The actuator mechanism according to any approach described herein may be attached to and/or be adapted to be used with many different hoist systems or object movers such as for example, but not limited to, the following: engine hoists, forklifts, tractors, overhead track and beam stationary hoist systems. The actuator mechanism may also be designed as part of a newly designed object mover, lifting or hoist type of system.

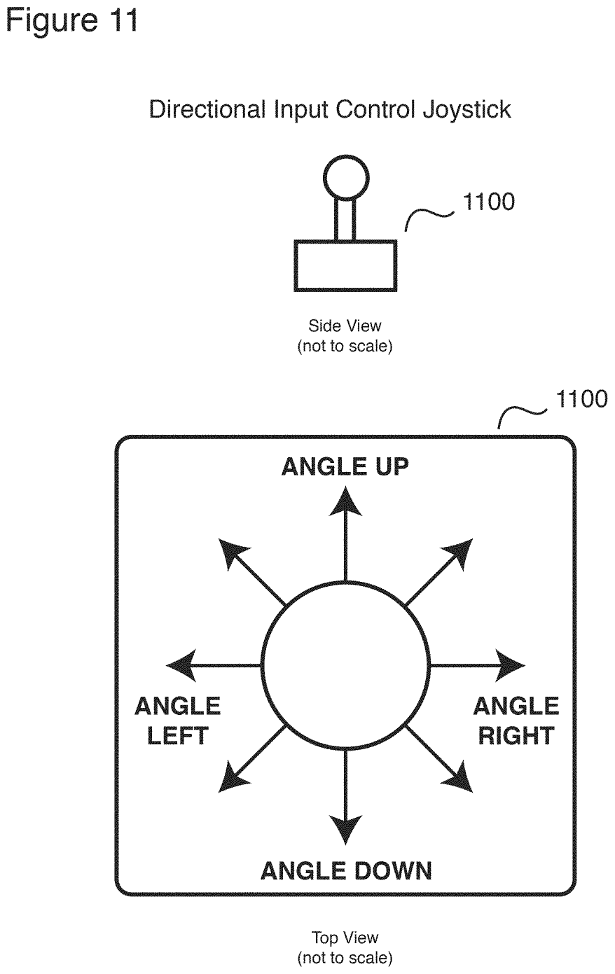

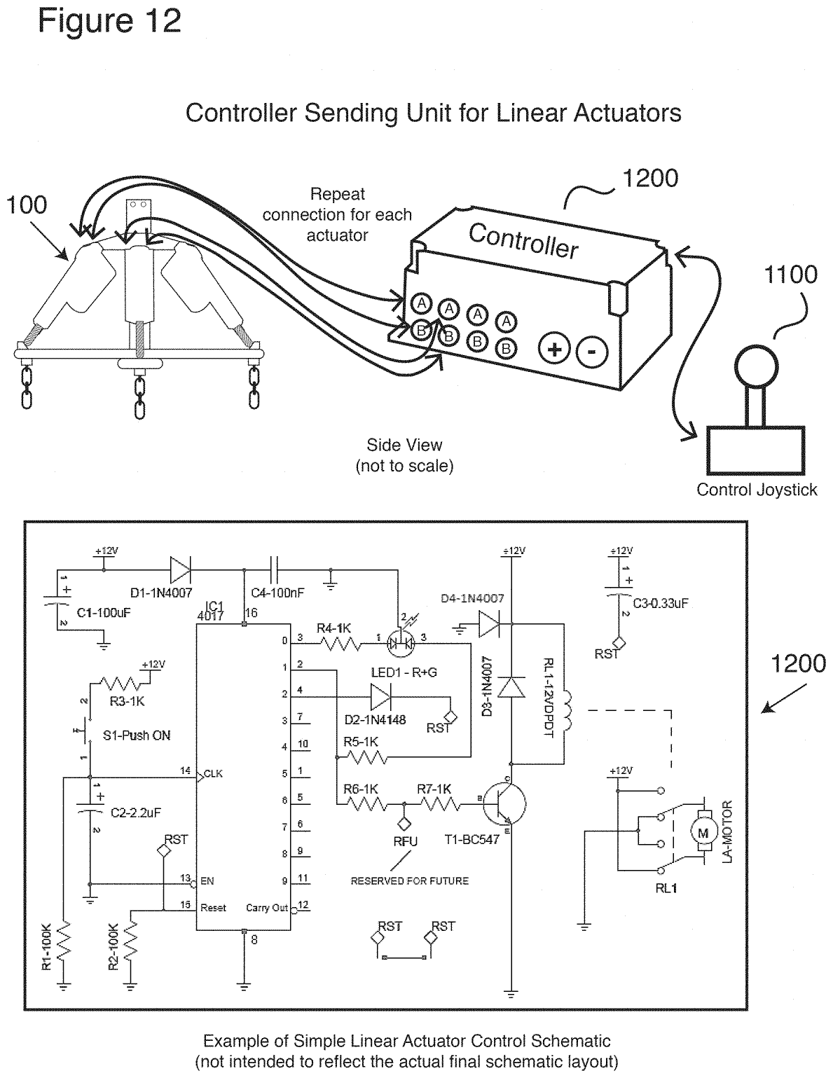

Any type of control mechanism may be used to control the actuator mechanism. The control mechanism may be external to the actuator mechanism, or part of an integrated device having the actuator mechanism. The actuator mechanism in some embodiments described herein is controlled by a joystick type input device 1100 interfacing with a control mechanism (Controller, 1200) that enables control of the correct combination of linear actuators to provide the desired movement and angle adjustment of the item being hoisted. See, e.g., FIGS. 11 and 12. In other approaches, the control mechanism includes dual joysticks, one or more knobs, one or more dials, one or more linear levers, etc. that control a specific type of movement or combination of movements. In yet another embodiment, the control mechanism includes a graphical user interface (GUI) output on a display of a computer, mobile device, etc. that is in communication with the device.

There has accordingly been described a novel and innovative device utilizing, e.g., multiple linear actuators working in unison to move bars that adjust the angles of a suspended object being lifted by a hoist. The actuator mechanism may be controlled by any appropriate input device, such as a joystick type input device interfacing with a control mechanism that is configured to start and stop the correct combination of linear actuators and/or load levelers for providing the desired movement and angle adjustment of the item being hoisted. This device enables an operator to adjust the angle of the object being lifted while simultaneously raising or lowering the object. The operator is able to remain clear of the object during lift procedures. This mechanism allows for precise and smooth adjustments to be made to the position of the object being lifted. Embodiments of the mechanism disclosed herein may be added as an accessory to existing hoists. The combination of enabling smooth and precise adjustments provides a much-improved way to lift and manipulate an engine for example, into the engine bay of an automobile, without damage or operator injury.

In use, the actuator mechanism may be used in a similar manner as existing hoists, albeit now with the many benefits described herein. In one embodiment, with the actuator mechanism installed on an existing hoist, forklift or as part of a new hoist system the following steps may be performed. The following procedure is presented by way of example only.
1) Attach lifting hooks to anchor bolts in engine block lifting points
2) Position actuator mechanism over motor
3) Connect the four chains to each lifting hook to couple motor to chains hanging from crossbars
4) Raise the forklift or hoist system being used with the actuator mechanism to create approximately even tension in all chains and a level starting lift position
5) Disconnect motor from vehicle in preparation to lift and remove motor
6) Lift motor, adjust tilt angle of motor while lifting and/or during a pause in the lifting action according to input from the joystick input control
7) During lift, continue to simultaneously adjust tilt angle of motor ensuring no unintended contact is made between motor and vehicle, using the joystick input control
8) Once motor is removed, the angle and tilt may be brought back to level using the joystick input control
9) The hoist can now be moved to another location to lower the motor onto a table and or other rack and chains may be removed to access and work on motor.

This process can be reversed to return the motor to the vehicle or install a new motor. Likewise, a similar process can be performed if the apparatus has one or more load levelers.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. An apparatus, comprising:
an actuator mechanism having a first crossbar oriented along an x-axis, a second crossbar oriented along a y-axis that is perpendicular to the x-axis, and at least one actuator coupled to each of the crossbars, the actuator mechanism being configured to provide controlled movement and setting of an x-axis angle and a y-axis angle of the respective crossbars in vertical planes extending along the respective axis.

2. The apparatus as recited in claim 1, comprising a control mechanism configured to control precise adjustment of the angle of the first crossbar in the plane that extends along the x-axis during lifting and/or lowering.

3. The apparatus as recited in claim 1, comprising a control mechanism configured to control precise adjustment of the angle of the second crossbar in the plane that extends along the y-axis during lifting and/or lowering.

4. The apparatus as recited in claim 1, comprising a control mechanism configured to control precise adjustment of compound angles and/or rotated angles of an item suspended from the crossbars during lifting and/or lowering.

5. The apparatus as recited in claim 4, comprising a joystick type input device interfacing with the control mechanism to start and stop the correct combination of actuators providing the desired movement and angle adjustment of the item being hoisted.

6. The apparatus as recited in claim 1, comprising a hoist, the actuator mechanism being coupled to the hoist.

7. The apparatus as recited in claim 1, comprising a forklift, the actuator mechanism being coupled to the forklift.

8. The apparatus as recited in claim 1, wherein the actuators are selected from the group consisting of: electric screw gear linear actuators, hydraulic piston linear actuators, pneumatic piston linear actuators and combinations thereof.

9. An apparatus, comprising:
an actuator mechanism for controlling orientation of an item suspended from the actuator mechanism, the actuator mechanism having:
at least one actuator coupled to a crossbar for providing controlled movement of the crossbar in an x-axis angle thereby controlling an x-axis angle of the item, and
a load leveler for providing controlled movement of the item in a y-axis angle.

10. The apparatus as recited in claim 9, comprising a control mechanism configured to control precise adjustment of both the x-axis and y-axis compound and/or rotated angles during lifting and/or lowering of the item.

11. An apparatus, comprising:
an actuator mechanism for controlling orientation of an item suspended from the actuator mechanism, the actuator mechanism having:
a first load leveler for providing controlled movement of the item in an x-axis angle, and
a second load leveler for providing controlled movement of the item in a y-axis angle.

12. The apparatus as recited in claim 11, comprising a control mechanism configured to control precise adjustment of both the x-axis and y-axis compound and/or rotated angles during lifting and/or lowering of the item.
